(19) United States
(12) Patent Application Publication
(10) Pub. No.: US 2024/0353107 A1
(43) Pub. Date: Oct. 24, 2024

(54) ANTI-DRY-BURN COOKTOP AND CONTROL METHOD THEREFOR

(71) Applicant: BSH Hausgeräte GmbH, Munich (DE)

(72) Inventor: Jinhua Wu, Nanjing City, Jiangsu Province (CN)

(21) Appl. No.: 18/681,527

(22) PCT Filed: Aug. 24, 2022
(86) PCT No.: PCT/EP2022/073546

§ 371 Date: Feb. 6, 2024

(30) Foreign Application Priority Data
Sep. 3, 2021 (CN) 202111030897.9

(51) Int. Cl. F24C 3/12; G08B 21/18

(52) U.S. Cl. CPC F24C 3/126; G08B 21/182

(57) ABSTRACT

An anti-dry-burn cooktop includes a solenoid valve, a temperature sensor configured to collect a temperature of a pot, a control unit configured to store a first temperature threshold and a second temperature threshold, with the first temperature threshold being less than the second temperature threshold, an alarm unit configured to issue alarm information based on an instruction from the control unit, and a user feedback receiving unit configured to receive an instruction from a user generated in response to the alarm information and to send the instruction to the control unit. The control unit is configured to control the alarm unit to issue the alarm information when the temperature of the pot is greater than the first temperature threshold and less than the second temperature threshold, and to control the solenoid valve to be turned off when the temperature of the pot is greater than the second temperature threshold.

### TECHNICAL FIELD

This application relates to the field of kitchen utensils, and in particular, to an anti-dry-burn cooktop and a control method therefor.

### BACKGROUND

In the related art, an anti-dry-burn function that is set in a household cooktop can automatically turn off the cooktop when the temperature of a pot reaches the anti-dry-burn temperature threshold. However, to ensure that a pot with oil is not likely to catch fire, an anti-dry-burn temperature is set relatively low, which leads to the problem of turning off the fire unexpectedly early in some high-temperature cooking occasions, affecting the cooking effect.

### SUMMARY

Objectives of this application are to provide an improved anti-dry-burn cooktop and a control method.

An aspect of embodiments of the present invention relates to an anti-dry-burn cooktop. The anti-dry-burn cooktop includes: a solenoid valve; a temperature sensor configured to collect a temperature of a pot; a control unit storing a first temperature threshold and a second temperature threshold, where the first temperature threshold is less than the second temperature threshold; an alarm unit configured to issue alarm information based on an instruction from the control unit; and a user feedback receiving unit configured to receive an instruction from a user generated in response to the alarm information and send the instruction to the control unit. The control unit is configured to: control the alarm unit to issue the alarm information when the temperature of the pot is greater than the first temperature threshold and less than the second temperature threshold; and control the solenoid valve to be turned off when the temperature of the pot is greater than the second temperature threshold.

By adopting this structure, when the temperature of the pot is greater than the first temperature threshold and less than the second temperature threshold, the cooktop is not controlled to automatically turn off the fire, but the alarm information is issued. After the alarm information is issued, the user feedback receiving unit may issue different instructions according to needs of the user. This can, on one hand, remind the user in time to pay attention to a cooking situation of the cooktop before dry burn or at the beginning of the dry burn, and on the other hand, provide the user with various choices instead of immediately turning off the fire, so that the user can make different choices as needed. The user can choose to turn off the fire or cancel an alarm to continue cooking. If high-temperature cooking is needed, the user can choose to cancel the alarm to continue cooking without automatically turning off gas, to reach a temperature needed for frying a dish. This can meet a need of an occasion where high-temperature cooking is needed.

By setting two temperature thresholds, the user can be provided with a possibility to choose. If the user needs to cook at a high temperature, a case that a needed temperature cannot be reached due to turning off the fire unexpectedly early can be avoided, so that a cooking effect is not affected.

In addition, for the sake of safety, when the temperature of the pot is greater than the second temperature threshold, the solenoid valve is turned off immediately, thereby cutting off gas supply to a burner through a gas supply pipeline. In this case, a need of the user for high-temperature cooking can be met, and a dry burn possibility can also be reduced, thereby improving safety of the cooktop and improving user experience.

In a possible implementation, the control unit is further configured as follows: after the alarm unit issues the alarm information, the user feedback receiving unit receives the alarm information and generates a fire-off instruction to be sent to the control unit, and after receiving the fire-off instruction from the user feedback receiving unit, the control unit controls the solenoid valve to be turned off. Therefore, after the alarm unit issues the alarm information, the user feedback receiving unit may issue the fire-off instruction if the user is not around the cooktop or does not need to cook at a high temperature, which not only meets a need of the user, but also can effectively reduce the dry burn possibility.

In a possible implementation, the control unit is further configured as follows: after the alarm unit issues the alarm information, the user feedback receiving unit receives the alarm information and generates an instruction of closing the alarm information to be sent to the control unit, and after receiving the instruction of closing the alarm information from the user feedback receiving unit, the control unit controls the alarm unit to stop issuing the alarm information. Therefore, after the alarm unit issues the alarm information, a cooking state of the cooktop can be monitored in time if the user is around the cooktop, or the user feedback receiving unit issues the instruction of closing the alarm information if the user needs a high-temperature cooking environment. The user can freely control the cooktop as needed. The user can choose to turn down the fire or maintain the fire, to achieve the needed high-temperature cooking environment, thereby improving the user experience.

In a possible implementation, the first temperature threshold is based on a temperature collected by the temperature sensor when a small amount of oil is put into the pot and the oil does not catch fire. Therefore, the first temperature threshold of the cooktop can be accurately obtained, thereby avoiding occurrence of a false anti-dry-burn determination, and improving the user experience.

In a possible implementation, a range of the first temperature threshold is less than or equal to 240 degrees and greater than or equal to 260 degrees.

In a possible implementation, when the temperature inside the pot is 300 degrees, a temperature collected by the temperature sensor is a first temperature. When an ambient temperature of the temperature sensor reaches a maximum value, a temperature collected by the temperature sensor is a second temperature. The second temperature threshold is a smaller one of the first temperature and the second temperature. Therefore, in a case that a condition that a temperature of the temperature sensor does not exceed a maximum ambient temperature and oil inside the pot does not catch fire is satisfied, the second temperature threshold is a value as large as possible, which can not only meet a safety condition and ensure that the temperature sensor is not damaged, but also meet a need for high-temperature cooking, thereby improving the user experience.

In a possible implementation, a range of the second temperature threshold is less than or equal to 280 degrees and greater than or equal to 300 degrees.

In a possible implementation, the alarm information includes sound, where a frequency of the sound is positively correlated with a temperature within an alarm range, and/or the alarm information includes light, where a flashing frequency of the light is positively correlated with a temperature within the alarm range. Therefore, the user not only can be notified in time, but also can determine a cooking state according to the frequency of the alarm sound and the flashing frequency of the light, to make a timely response, thereby effectively avoiding occurrence of the dry burn and improving safety performance of the cooktop.

In a possible implementation, the alarm information includes a buzzer, an LED indicator, or voice broadcast.

Another objective of the present invention is to provide a control method for an anti-dry-burn cooktop. The cooktop includes: a solenoid valve; a temperature sensor configured to collect a temperature of a pot; a control unit storing a first temperature threshold and a second temperature threshold, where the first temperature threshold is less than the second temperature threshold; an alarm unit configured to issue alarm information based on an instruction from the control unit; and a user feedback receiving unit configured to receive an instruction from a user generated in response to the alarm information and send the instruction to the control unit. The control method includes:
a. collecting, by the temperature sensor, the temperature of the pot;
b. determining whether the temperature of the pot is greater than the first temperature threshold and less than the second temperature threshold, and if the temperature of the pot is greater than the first temperature threshold and less than the second temperature threshold, controlling, by the control unit, the alarm unit to issue the alarm information; and
c. determining whether the temperature of the pot is greater than the second temperature threshold, and if the temperature of the pot is greater than the second temperature threshold, controlling, by the control unit, the solenoid valve to be turned off.

By adopting this method and this structure, when the temperature of the pot is greater than the first temperature threshold and less than the second temperature threshold, the cooktop is not controlled to automatically turn off the fire, but the alarm information is issued. After the alarm information is issued, the user feedback receiving unit may issue different instructions according to needs of the user. This can, on one hand, remind the user in time to pay attention to a cooking situation of the cooktop before dry burn or at the beginning of the dry burn, and on the other hand, provide the user with various choices instead of immediately turning off the fire, so that the user can make different choices as needed. The user can choose to turn off the fire or cancel the alarm to continue cooking. If high-temperature cooking is needed, the user can choose to cancel the alarm to continue cooking without automatically turning off gas, to reach the temperature needed for frying a dish. This can meet a need of an occasion where high-temperature cooking is needed.

By setting two temperature thresholds, the user can be provided with a possibility to choose. If the user needs to cook at a high temperature, a case that a needed temperature cannot be reached due to turning off the fire unexpectedly early can be avoided, so that a cooking effect is not affected.

In addition, for the sake of safety, when the temperature of the pot is greater than the second temperature threshold, the solenoid valve is turned off immediately, thereby cutting off gas supply to a burner through a gas supply pipeline. In this case, a need of the user for high-temperature cooking can be met, and a dry burn possibility can also be reduced, thereby improving safety of the cooktop and improving the user experience.

In a possible implementation, the control method further includes: d. after the alarm unit issues the alarm information, receiving, by the user feedback receiving unit, the alarm information and generating a fire-off instruction to be sent to the control unit, and after receiving the fire-off instruction from the user feedback receiving unit, controlling, by the control unit, the solenoid valve to be turned off. Therefore, after the alarm unit issues the alarm information, the user feedback receiving unit may issue the fire-off instruction if the user is not around the cooktop or does not need to cook at a high temperature, which not only meets a need of the user, but also can effectively reduce the dry burn possibility.

In a possible implementation, the control method further includes: e. after the alarm unit issues the alarm information, receiving, by the user feedback receiving unit, the alarm information and generating an instruction of closing the alarm information to be sent to the control unit, and after receiving the instruction of closing the alarm information from the user feedback receiving unit, controlling, by the control unit, the alarm unit to stop issuing the alarm information. Therefore, after the alarm unit issues the alarm information, a cooking state of the cooktop can be monitored in time if the user is around the cooktop, or the user feedback receiving unit issues the instruction of closing the alarm information if the user needs a high-temperature cooking environment. The user can freely control the cooktop as needed. The user can choose to turn down the fire or maintain the fire, to achieve the needed high-temperature cooking environment, thereby improving the user experience.

In a possible implementation, the first temperature threshold is based on a temperature collected by the temperature sensor when a small amount of oil is put into the pot and the oil does not catch fire. Therefore, the first temperature threshold of the cooktop can be accurately obtained, thereby avoiding occurrence of a false anti-dry-burn determination, and improving the user experience.

In a possible implementation, a range of the first temperature threshold is less than or equal to 240 degrees and greater than or equal to 260 degrees.

In a possible implementation, when the temperature inside the pot is 300 degrees, a temperature collected by the temperature sensor is a first temperature. When an ambient temperature of the temperature sensor reaches a maximum value, a temperature collected by the temperature sensor is a second temperature. The second temperature threshold is a smaller one of the first temperature and the second temperature. Therefore, in a case that a condition that a temperature of the temperature sensor does not exceed a maximum ambient temperature and oil inside the pot does not catch fire is satisfied, the second temperature threshold is a value as large as possible, which can not only meet a safety condition, but also meet a need for high-temperature cooking, thereby improving the user experience.

In a possible implementation, a range of the second temperature threshold is less than or equal to 280 degrees and greater than or equal to 300 degrees.

### BRIEF DESCRIPTION OF THE DRAWINGS

FIG. 1 is a principle diagram of an electric appliance according to an embodiment of the present invention; and

FIG. 2 is a flowchart of a control method according to an embodiment of the present invention.

### REFERENCE NUMERALS

Control unit 100
Alarm unit 200
Temperature sensor 300
Solenoid valve 400
User feedback receiving unit 500

### DETAILED DESCRIPTION

For a further understanding of the objectives, structures, features and functions of this application, a detailed description is made below in cooperation with embodiments.

An anti-dry-burn cooktop of an implementation of the present invention includes a solenoid valve 400, a cooktop body, and a control unit 100. A burner head is arranged on the cooktop body. A pot is placed on a pot support. Flame generated by the burner head is used to heat the pot on the pot support.

A first temperature threshold and a second temperature threshold are pre-stored in the control unit 100, where the first temperature threshold is less than the second temperature threshold.

The cooktop further includes a gas pipeline and a gas valve mounted in the gas pipeline, where the gas pipeline is connected to the cooktop body and supplies gas to the cooktop body. The gas valve is a plug valve. A user may adjust a gas flow supplied to a burner by manually adjusting a knob of the gas valve, to control the flame magnitude of the burner head.

The cooktop further includes the solenoid valve 400. The solenoid valve 400 and the gas valve are connected in series and mounted in the gas pipeline. The control unit 100 is connected to the solenoid valve 400, and controls the solenoid valve 400 to be turned on or turned off, to control gas supply.

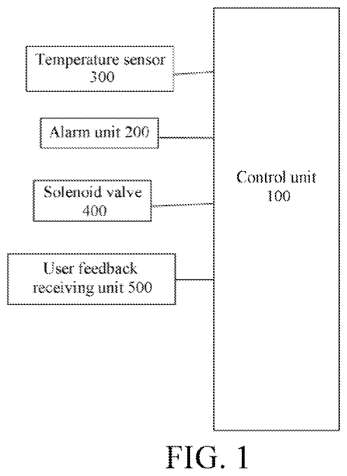

As shown in FIG. 1, the cooktop further includes a temperature sensor 300 and an alarm unit 200. The temperature sensor 300 is configured to collect a temperature of the pot, and the alarm unit 200 is configured to issue alarm information. The control unit 100 is electrically connected to the temperature sensor 300 and the alarm unit 200. The temperature sensor 300 transmits information about the collected temperature of the pot to the control unit 100. The alarm unit 200 issues the alarm information based on an instruction issued by the control unit 100.

The cooktop further includes a user feedback receiving unit 500 that is electrically connected to the control unit 100 and configured to receive an instruction from the user generated in response to the alarm information and send the instruction to the control unit 100.

The control unit 100 is configured to: control the alarm unit 200 to issue the alarm information when the temperature of the pot is greater than the first temperature threshold and less than the second temperature threshold; and control the solenoid valve 400 to be turned off when the temperature of the pot is greater than the second temperature threshold, thereby turning off the gas supply.

When the temperature of the pot is greater than the first temperature threshold and less than the second temperature threshold, the cooktop is not controlled to automatically turn off the fire, but the alarm information is issued. After the alarm information is issued, the user feedback receiving unit 500 may issue different instructions according to needs of the user. This can, on one hand, remind the user in time to pay attention to a cooking situation of the cooktop before dry burn or at the beginning of the dry burn, and on the other hand, provide the user with various choices instead of automatically turning off the fire, so that the user can make different choices as needed. The user can choose to turn off the fire or cancel an alarm to continue cooking. If high-temperature cooking is needed, the user can choose to cancel the alarm to continue cooking without automatically turning off gas, to reach a temperature needed for frying a dish. This can meet a need of an occasion where high-temperature cooking is needed.

By setting two temperature thresholds, the user can be provided with a possibility to choose. If the user needs to cook at a high temperature, a case that a needed temperature cannot be reached due to turning off the fire unexpectedly early can be avoided, so that a cooking effect is not affected.

The second temperature threshold is greater than the first temperature threshold. When the temperature of the cooktop exceeds the second temperature threshold, the control unit 100 sends a turn-off instruction to the solenoid valve 400, to immediately turn off the solenoid valve 400 and cut off the gas supply to the burner through the gas supply pipeline, so that the cooktop is turned off. In this case, a need of the user for high-temperature cooking is met, and the safety of the cooktop is also ensured, thereby improving intelligence of the cooktop as well as the user experience.

After the alarm information is issued, the user makes different responses according to the alarm information, for example, the user cancels an alarm through an alarm canceling button, performs a corresponding operation on an APP, has not received the alarm information and makes no response, or intends to automatically turn off the fire, or the like. The user feedback receiving unit 500 may generate different instructions according to the responses of the user, and send the instructions to the control unit 100.

If the user makes no response or the user intends to turn off the fire without taking other measures after the alarm information is issued, the user feedback receiving unit 500 then generates a fire-off instruction according to the responses and sends the fire-off instruction to the control unit 100. After receiving the fire-off instruction from the user feedback receiving unit 500, the control unit 100 controls the solenoid valve 400 to be turned off, thereby turning off the gas supply.

If the user needs a high-temperature cooking environment, the user may operate the alarm canceling button or perform the corresponding operation on the APP. The user feedback receiving unit 500 then issues an instruction of closing the alarm information according to the responses and sends the instruction to the control unit 100. After receiving the instruction of closing the alarm information from the user feedback receiving unit 500, the control unit 100 controls the alarm unit 200 to stop issuing the alarm information. The solenoid valve 400 makes no action, to provide the high-temperature cooking environment needed by the user, thereby meeting a personalized need of the user and improving the user experience.

The first temperature threshold is based on a temperature collected by the temperature sensor 300 when a small amount of oil is put into the pot and the oil does not catch fire. A range of the first temperature threshold is less than or equal to 240 degrees and greater than or equal to 260 degrees.

When the temperature inside the pot is 300 degrees, a temperature collected by the temperature sensor 300 is a first temperature. When an ambient temperature of the temperature sensor 300 reaches a maximum value, a temperature collected by the temperature sensor 300 is a second temperature. The second temperature threshold is a smaller one of the first temperature and the second temperature. A range of the second temperature threshold is less than or equal to 280 degrees and greater than or equal to 300 degrees.

Therefore, in a case that a condition that a temperature of the temperature sensor 300 does not exceed a maximum ambient temperature and oil inside the pot does not catch fire is satisfied, the second temperature threshold is a value as large as possible, which can not only meet a safety condition and ensure that the temperature sensor 300 is not damaged, but also meet a need for high-temperature cooking, thereby improving the user experience.

The alarm information may be in different forms.

In an embodiment, the alarm information may include sound, where a frequency of the sound is positively correlated with a temperature within an alarm range, and/or the alarm information may include light, where a flashing frequency of the light is positively correlated with a temperature within the alarm range.

In another embodiment, the alarm information may further include a buzzer, an LED indicator, or voice broadcast.

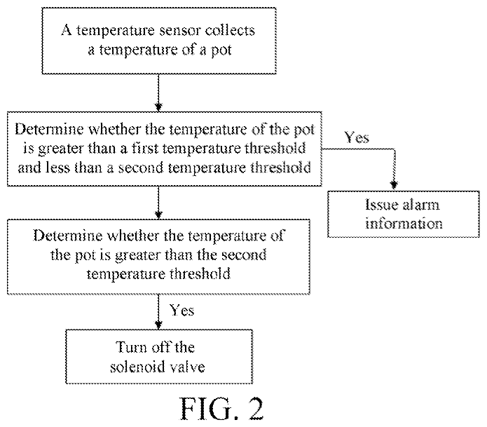

As shown in FIG. 2, the present invention further provides the following technical solution: a control method for a dry-burn prevention cooktop. The cooktop includes: a solenoid valve 400; a temperature sensor 300 configured to collect a temperature of a pot; a control unit 100 storing a first temperature threshold and a second temperature threshold, where the first temperature threshold is less than the second temperature threshold; an alarm unit 200 configured to issue alarm information based on an instruction from the control unit 100; and a user feedback receiving unit 500 configured to receive an instruction from a user generated in response to the alarm information and send the instruction to the control unit 100. The control method includes:
a. collecting, by the temperature sensor 300, the temperature of the pot;
b. determining whether the temperature of the pot is greater than the first temperature threshold and less than the second temperature threshold, and if the temperature of the pot is greater than the first temperature threshold and less than the second temperature threshold, controlling, by the control unit 100, the alarm unit 200 to issue the alarm information; and
c. determining whether the temperature of the pot is greater than the second temperature threshold, and if the temperature of the pot is greater than the second temperature threshold, controlling, by the control unit 100, the solenoid valve 400 to be turned off. By adopting this method, when the temperature of the pot is greater than the first temperature threshold and less than the second temperature threshold, the cooktop is not controlled to automatically turn off the fire, but the alarm information is issued. After the alarm information is issued, the user feedback receiving unit 500 may issue different instructions according to needs of the user.

This can, on one hand, remind the user in time to pay attention to a cooking situation of the cooktop before dry burn or at the beginning of the dry burn, and on the other hand, provide the user with various choices instead of immediately turning off the fire, so that the user can make different choices as needed. The user can choose to turn off the fire or cancel the alarm. If high-temperature cooking is needed, the user can choose to cancel the alarm to continue cooking without automatically turning off gas, to reach a temperature needed for frying a dish. This can meet a need of an occasion where high-temperature cooking is needed.

By setting two temperature thresholds, the user can be provided with a possibility to choose. If the user needs to cook at a high temperature, a case that a needed temperature cannot be reached due to turning off the fire unexpectedly early can be avoided, so that a cooking effect is not affected.

In addition, for the sake of safety, when the temperature of the pot is greater than the second temperature threshold, the solenoid valve 400 is turned off immediately, thereby cutting off gas supply to a burner through a gas supply pipeline. In this case, a need of the user for high-temperature cooking can be met, and a dry burn possibility can also be reduced, thereby improving safety of the cooktop and improving user experience.

Setting of the first temperature threshold and the second temperature threshold has been described above, and therefore details are not described herein again.

The control method may further include: d. after the alarm unit 200 issues the alarm information, receiving, by the user feedback receiving unit 500, the alarm information and generating a fire-off instruction to be sent to the control unit 100, and after receiving the fire-off instruction from the user feedback receiving unit 500, controlling, by the control unit 100, the solenoid valve 400 to be turned off.

The control method may further include: e. after the alarm unit 200 issues the alarm information, receiving, by the user feedback receiving unit, the alarm information and generating an instruction of closing the alarm information to be sent to the control unit 100, and after receiving the instruction of closing the alarm information from the user feedback receiving unit 500, controlling, by the control unit 100, the alarm unit 200 to stop issuing the alarm information.

Various embodiments illustrated with reference to FIG. 1 to FIG. 2 may be combined with each other in any given manner to realize the advantage of the present invention. In addition, the present invention is not limited to the shown embodiments. Usually, apart from the shown means, other means can also be used as long as the means can also achieve the same effect.

1-16. (canceled)

17. An anti-dry-burn cooktop, comprising:
a solenoid valve;
a temperature sensor configured to collect a temperature of a pot;
a control unit configured to store a first temperature threshold and a second temperature threshold, with the first temperature threshold being less than the second temperature threshold;
an alarm unit configured to issue alarm information based on an instruction from the control unit; and
a user feedback receiving unit configured to receive an instruction from a user generated in response to the alarm information and to send the instruction to the control unit,
wherein the control unit is configured to control the alarm unit to issue the alarm information when the temperature of the pot is greater than the first temperature threshold and less than the second temperature threshold, and to control the solenoid valve to be turned off when the temperature of the pot is greater than the second temperature threshold.

18. The anti-dry-burn cooktop according to claim 17, wherein the control unit is configured to turn off the solenoid valve after receiving from the user feedback receiving unit a fire-off instruction generated by the user feedback receiving unit after receiving the alarm information from the alarm unit.

19. The anti-dry-burn cooktop according to claim 17, wherein the control unit is configured to control the alarm unit to stop issuing the alarm information after receiving from the user feedback receiving unit an instruction of closing the alarm information which instruction is generated by the user feedback receiving unit after receiving the alarm information from the alarm unit.

20. The anti-dry-burn cooktop according to claim 17, wherein the first temperature threshold is based on a temperature collected by the temperature sensor when a small amount of oil is put into the pot and the oil does not catch fire.

21. The anti-dry-burn cooktop according to claim 17, wherein a range of the first temperature threshold is less than or equal to 240 degrees and greater than or equal to 260 degrees.

22. The anti-dry-burn cooktop according to claim 17, wherein the temperature collected by the temperature sensor is a first temperature when the temperature inside the pot is 300 degrees, and the temperature collected by the temperature sensor is a second temperature when an ambient temperature of the temperature sensor reaches a maximum value, wherein the second temperature threshold is a smaller one of the first temperature and the second temperature.

23. The anti-dry-burn cooktop according to claim 17, wherein a range of the second temperature threshold is less than or equal to 280 degrees and greater than or equal to 300 degrees.

24. The anti-dry-burn cooktop according to claim 17, wherein the alarm information comprises sound of a frequency which is positively correlated with a temperature within an alarm range; and/or the alarm information comprises light of a flashing frequency which is positively correlated with a temperature within the alarm range.

25. The anti-dry-burn cooktop according to claim 17, wherein the alarm information comprises a buzzer, an LED indicator, or voice broadcast.

26. A control method for an anti-dry-burn cooktop, the control method comprising:
storing in a control unit a first temperature threshold and a second temperature threshold, with the first temperature threshold being less than the second temperature threshold;
collecting a temperature of a pot on the cooktop by a temperature sensor;
determining whether the temperature of the pot is greater than the first temperature threshold and less than the second temperature threshold and if affirmative the control unit controlling an alarm unit to issue an alarm information based on an instruction from the control unit, and
determining whether the temperature of the pot is greater than the second temperature threshold, and if affirmative, the control unit controlling a solenoid valve to be turned off.

27. The control method according to claim 26, further comprising:
after the alarm unit issues the alarm information, transmitting the alarm information to a user feedback receiving unit;
the user feedback receiving unit generating a fire-off instruction to be sent to the control unit when receiving the alarm information; and
the control unit, after receiving the fire-off instruction from the user feedback receiving unit, controlling the solenoid valve to be turned off.

28. The control method according to claim 26, further comprising:
after the alarm unit issues the alarm information, transmitting the alarm information to a user feedback receiving unit;
the user feedback receiving unit generating an instruction of closing the alarm information to be sent to the control unit when receiving the alarm information; and
the control unit, after receiving the instruction of closing the alarm information from the user feedback receiving unit, controlling the alarm unit to stop issuing the alarm information.

29. The control method according to claim 26, wherein the first temperature threshold is based on a temperature collected by the temperature sensor when a small amount of oil is put into the pot and the oil does not catch fire.

30. The control method according to claim 26, wherein a range of the first temperature threshold is less than or equal to 240 degrees and greater than or equal to 260 degrees.

31. The control method according to claim 26, wherein the temperature collected by the temperature sensor is a first temperature when the temperature inside the pot is 300 degrees, and the temperature collected by the temperature sensor is a second temperature when an ambient temperature of the temperature sensor reaches a maximum value, wherein the second temperature threshold is a smaller one of the first temperature and the second temperature.

32. The control method according to claim 26, wherein a range of the second temperature threshold is less than or equal to 280 degrees and greater than or equal to 300 degrees.
